(19) United States
(12) Patent Application Publication
(10) Pub. No.: US 2026/0282020 A1
(43) Pub. Date: Sep. 17, 2026

(54) UPLINK TRANSMISSION EXECUTION METHOD AND DEVICE, UPLINK TRANSMISSION RECEIVING METHOD AND DEVICE, COMMUNICATION DEVICE, AND STORAGE MEDIUM

(71) Applicant: Beijing Xiaomi Mobile Software Co., Ltd., Beijing (CN)

(72) Inventor: Lei WANG, Beijing (CN)

(73) Assignee: Beijing Xiaomi Mobile Software Co., Ltd., Beijing (CN)

(21) Appl. No.: 19/469,684

(22) PCT Filed: Mar. 29, 2023
(86) PCT No.: PCT/CN2023/084891

§ 371 Date: Sep. 26, 2025

(51) Int. Cl. H04W 72/21; H04W 72/0453

(52) U.S. Cl. CPC H04W 72/21; H04W 72/0453

(57) ABSTRACT

A method for performing uplink transmission, performed by a terminal, includes: determining, in a case where uplink transmissions are to be performed in a plurality of slots and according to a relation between a frequency domain resource for an uplink transmission in a first slot among the plurality of slots and an uplink subband in the first slot, whether to perform the uplink transmission in the first slot.

### CROSS REFERENCE TO RELATED APPLICATION

The present application is a U.S. National Stage of International Application No. PCT/CN2023/084891, filed on Mar. 29, 2023, the entire contents of which are incorporated herein by reference.

### BACKGROUND OF THE INVENTION

To achieve full-duplex communication, a network device may configure a subband in a slot; for example, the network device may configure an uplink subband in a downlink slot. Thus, in the downlink slot, the network device may perform uplink communication by using a frequency domain resource for the uplink subband, and/or perform downlink communication by using a frequency domain resource except the frequency domain resource for the uplink subband. However, an existing method for performing communication based on the subband has some problems.

### SUMMARY OF THE INVENTION

According to a first aspect of the embodiments of the present disclosure, a method for performing uplink transmission is provided. The method is performed by a terminal, and includes: determining, in a case where uplink transmissions are to be performed in a plurality of slots and according to a relation between a frequency domain resource for an uplink transmission in a first slot among the plurality of slots and an uplink subband in the first slot, whether to perform the uplink transmission in the first slot.

According to a second aspect of the embodiments of the present disclosure, a method for receiving uplink transmission is provided. The method is performed by a network device, and includes determining, in a case where uplink transmissions of a terminal are to be received in a plurality of slots and according to a relation between a frequency domain resource for an uplink transmission in a first slot among the plurality of slots and an uplink subband in the first slot, whether to receive the uplink transmission in the first slot.

According to a third aspect of the embodiments of the present disclosure, a communication device is provided. The communication device includes a processor and a memory configured to store a computer program, where the computer program, when executed by the processor, implements the above method for performing uplink transmission.

According to a fourth aspect of the embodiments of the present disclosure, a communication device is provided. The communication device includes a processor and a memory configured to store a computer program, where the computer program, when executed by the processor, implements the above method for receiving uplink transmission.

### BRIEF DESCRIPTION OF DRAWINGS

In order to describe technical solutions in embodiments of the present disclosure more clearly, the accompanying drawings required for the description of the embodiments are briefly introduced below. Obviously, the accompanying drawings in the following description show merely some embodiments of the present disclosure, and those of ordinary skill in the art would further be able to derive other accompanying drawings from these accompanying drawings without making creative efforts.

FIG. 1 is a schematic diagram of an application scenario according to an embodiment of the present disclosure.

FIG. 2 is a schematic diagram showing that a network device performs full-duplex communication in a subband full duplex (SBFD) slot according to an embodiment of the present disclosure.

FIG. 3 is a schematic diagram of a center frequency point of a bandwidth part according to an embodiment of the present disclosure.

FIG. 4 is a schematic flowchart of a method for performing uplink transmission according to an embodiment of the present disclosure.

FIGS. 5A and 5B are schematic diagrams of application scenarios of a method for performing uplink transmission according to an embodiment of the present disclosure.

FIGS. 6A and 6B are schematic diagrams of application scenarios of another method for performing uplink transmission according to an embodiment of the present disclosure.

FIG. 6C is a schematic diagram of a third slot according to an embodiment of the present disclosure.

FIG. 7 is a schematic flowchart of a method for receiving uplink transmission according to an embodiment of the present disclosure. The method for receiving uplink transmission, as shown in the embodiment, may be performed by a network device.

FIG. 8 is a schematic block diagram of a device for performing uplink transmission according to an embodiment of the present disclosure.

FIG. 9 is a schematic block diagram of a device for receiving uplink transmission according to an embodiment of the present disclosure.

FIG. 10 is a schematic block diagram of a device for receiving uplink transmission according to an embodiment of the present disclosure.

FIG. 11 is a schematic block diagram of a device for performing uplink transmission according to an embodiment of the present disclosure.

### DETAILED DESCRIPTION OF THE INVENTION

The implementations or the embodiments of the present disclosure are not exhaustive, and are merely illustrative of some implementations or embodiments, and do not serve as specific limitations on the scope of protection of the present disclosure. Each step in an implementation or an embodiment can be implemented as an independent embodiment without contradiction, and the steps can be freely combined. For example, a solution in which part of the steps are removed in an implementation or an embodiment can be implemented as an independent embodiment, and the order of the steps in an implementation or an embodiment can be freely exchanged. In addition, alternatives or alternative examples in an implementation or embodiment can be freely combined. In addition, various implementations or embodiments can be freely combined. For example, part or all of the steps of different implementations or embodiments can be freely combined, and an implementation or an embodiment can be freely combined with alternatives or alternative examples of other implementations or embodiments.

In some implementations or embodiments, “in response to,” “under the condition that,” “at the time of,” “when,” “if,” “in a case where,” etc., in the present disclosure can be substituted for each other.

In some implementations or embodiments, the description modes of “A or B,” “A and/or B,” “at least one of A or B,” “in one case of, A, and in another case of, B,” “in response to one case, A, and in response to another case, B,” etc. of the present disclosure can include at least one of the following technical solutions according to cases: A is performed independently of B, i.e. A is performed in some implementations or embodiments; B is performed independently of A, i.e. B is performed in some implementations or embodiments; A and B are selectively performed, i.e. one of A and B is selected to be performed in some implementations or embodiments; and A and B are performed, i.e. A and B are performed in some implementations or embodiments.

In some implementations or embodiments, “comprise A,” “include A,” “configured to indicate A,” and “carry A” in the present disclosure can be interpreted as directly carrying A or indirectly indicating A.

Moreover, each element, each row, or each column in the tables to which the present disclosure relates can be implemented as an independent embodiment, and a combination of any element, any row, and any column can be implemented as an independent embodiment.

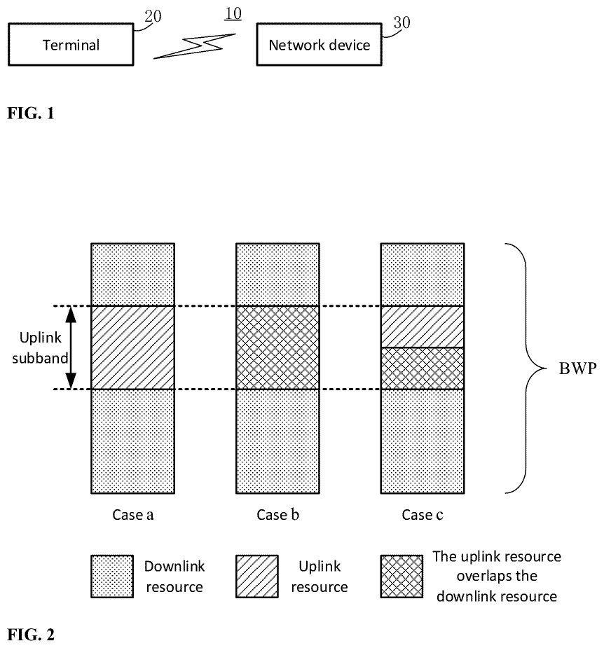

FIG. 1 is a schematic diagram of an application scenario according to an embodiment of the present disclosure.

As shown in FIG. 1, the embodiment of the present disclosure is applicable to a scenario in which a terminal 20 communicates with a network device 30, but is not limited to the scenario. Each entity shown in FIG. 1 is an example. An implementation or an embodiment of the present disclosure may include all or part of the entities shown in FIG. 1, or other entities except those shown in FIG. 1. A number of the entities is arbitrary, and is not limited to FIG. 1. Each connection relation shown in FIG. 1 is an example. The entities may be connected or not connected, and the entities may be connected in any manner. For example, the entities may be connected directly or indirectly, or the entities may be connected via wired or wireless connections.

In an embodiment, the terminal 20 includes, but is not limited to, a communication device such as a mobile phone, a tablet computer, a wearable device, a sensor, and an Internet of Things device. The terminal 20 may communicate with the network device 30, which includes, but is not limited to, a network device in communication systems such as fourth-generation mobile communication (4G), fifth-generation mobile communication (5G), and sixth-generation mobile communication (6G), such as a base station and a core network.

In an embodiment, the network device 30 may configure a subband for the terminal 20. For example, the network device 30 may configure an uplink subband for the terminal 20 in a first slot. For example, the network device 30 may configure a downlink subband for the terminal 20 in a second slot.

The first slot includes at least one of the following: a downlink slot or a flexible slot. The second slot includes at least one of the following: an uplink slot or a flexible slot.

The network device 30 may perform full-duplex communication in the first slot and the second slot. Thus, the first slot and the second slot may also be referred to as subband full duplex (SBFD) slots. The first slot is an SBFD slot with the configured uplink subband, and the second slot is an SBFD slot with the configured downlink subband. The terminal 20 may be a terminal capable of performing half-duplex communication in the SBFD slot. For example, in the SBFD slot, the terminal 20 may perform uplink transmission but may not receive downlink transmission, or may receive the downlink transmission but may not perform the uplink transmission.

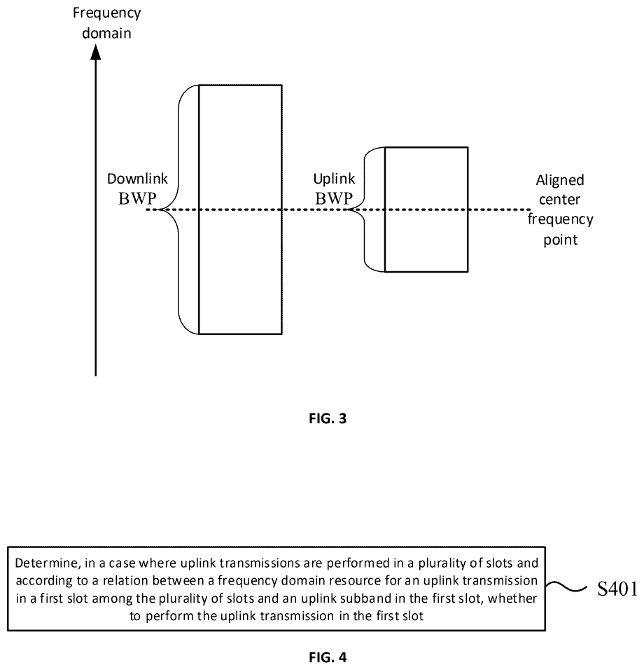

FIG. 2 is a schematic diagram showing that the network device performs the full-duplex communication in the SBFD slot according to an embodiment of the present disclosure.

As shown in FIG. 2, for example, the network device configures the uplink subband for the terminal in the downlink slot. For example, a frequency domain resource corresponding to the downlink slot includes at least one bandwidth part (BWP).

As shown in case A in FIG. 2, the network device may perform the uplink communication with the terminal in the uplink subband in the downlink slot, and may further perform the downlink communication with the terminal in a frequency domain resource outside the uplink subband. An uplink resource for the uplink communication may not overlap a downlink resource for the downlink communication. It should be noted that a terminal performing the uplink communication and a terminal performing the downlink communication in the same slot may be different terminals.

As shown in case B in FIG. 2, the network device may perform the uplink communication with the terminal in the uplink subband in the downlink slot, and may further perform the downlink communication with the terminal in the uplink subband. The uplink resource for the uplink communication may completely overlap the downlink resource for the downlink communication.

As shown in case C in FIG. 2, the network device may perform the uplink communication with the terminal in the uplink subband in the downlink slot, and may further perform the downlink communication with the terminal in the uplink subband and the frequency domain resource outside the uplink subband. The uplink resource for the uplink communication may partially overlap the downlink resource for the downlink communication.

FIG. 3 is a schematic diagram of a center frequency point of a bandwidth part according to an embodiment of the present disclosure.

In an embodiment, the SBFD slot may correspond to a time division duplexing (TDD) frequency band in a frequency domain, and the network device may configure an uplink bandwidth part and a downlink bandwidth part for the terminal in the TDD frequency band. As shown in FIG. 3, the network device may align a center frequency point of the uplink bandwidth part with a center frequency point of the downlink bandwidth part, and then configure, to the terminal, the uplink bandwidth part and the downlink bandwidth part after the center frequency points are aligned.

It should be noted that frequency domain ranges of the downlink bandwidth part and the uplink bandwidth part may be the same or different, which is not limited in the present disclosure.

For example, a slot structure configured by the network device for the terminal via TDD uplink (UL)-downlink (DL) configuration is DDDDDDSUUU. D represents the downlink slot, U represents the uplink slot, and S represents the flexible slot. That is, in 10 slots, a slot #0 to a slot #5 are downlink slots, a slot #6 is the flexible slot, and a slot #7 to a slot #9 are uplink slots.

The frequency domain resource corresponding to the downlink slot may include the downlink bandwidth part, and a frequency domain resource corresponding to the uplink slot may include the uplink bandwidth part.

In an embodiment, an operation of aligning the center frequency point of the uplink bandwidth part with the center frequency point of the downlink bandwidth part is applicable to a scenario of communication based on unpaired spectrum or a scenario of communication based on paired spectrum.

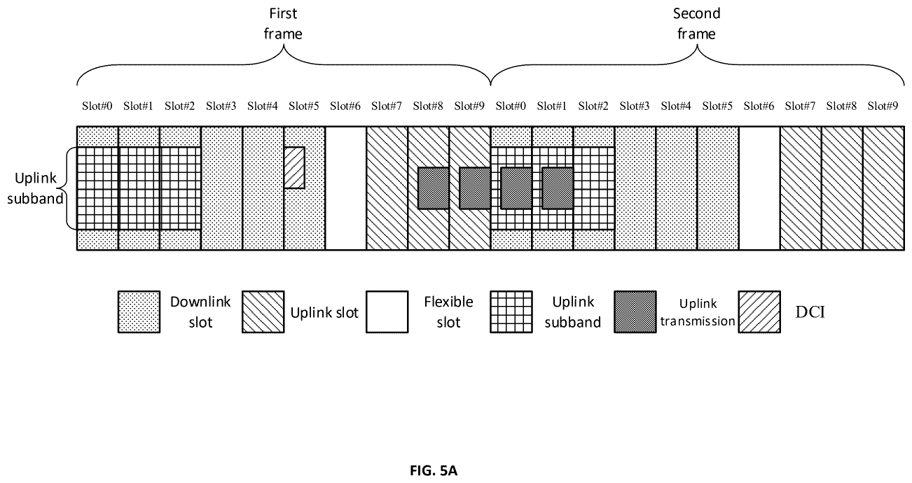

FIG. 4 is a schematic flowchart of a method for performing uplink transmission according to an embodiment of the present disclosure. The method for performing the uplink transmission shown in the embodiment may be performed by the terminal. As shown in FIG. 4, the method for performing the uplink transmission may include the following step S401.

In step S401, whether to perform an uplink transmission in a first slot is determined in a case where uplink transmissions are to be performed in a plurality of slots and according to a relation between a frequency domain resource for the uplink transmission in the first slot among the plurality of slots and an uplink subband in the first slot.

It should be noted that the plurality of slots occupied by the uplink transmissions may include at least one first slot. The first slot in the embodiment of the present disclosure may be one or a plurality of first slots of the at least one first slot.

In an embodiment, the uplink transmissions may occupy the plurality of slots in a case where the terminal needs to perform the uplink transmissions in the plurality of slots. The uplink transmissions occupying the plurality of slots may include repetitions of a signal or a channel, or transmissions of a plurality of signals and/or a plurality of channels without repetitions. A type of the uplink transmission is described in subsequent embodiments, and is not described here.

In an embodiment, the network device may configure the terminal to perform the uplink transmissions in the plurality of slots. The plurality of slots occupied by the uplink transmissions may be a plurality of continuous slots or a plurality of discontinuous slots, which is not limited in the present disclosure.

Since the uplink transmissions occupy the plurality of slots, it is difficult for the network device to ensure, in some cases, that each slot occupied by the uplink transmissions is a third slot in which a subband is not configured, where the third slot is a non-SBFD slot. The third slot includes at least one of the following: an uplink slot or a flexible slot.

For example, the uplink transmission includes a physical uplink shared channel (PUSCH) for which a repetition is enabled. For example, the terminal is configured to repeat n PUSCH transmissions, and n PUSCHs occupy n slots. The network device may determine that one third slot is a slot of a first PUSCH transmission among the n PUSCH transmissions, but the first slot exists after the third slot. Since a second PUSCH transmission to an n-th PUSCH transmission among the n PUSCH transmissions may occupy n-1 slots after the third slot, it may be difficult to ensure that the first slot is not occupied. In a case where a PUSCH transmission needs to occupy the first slot, the first slot cannot be used for the PUSCH transmission since the first slot is configured with the uplink subband, and a resource outside the uplink subband may not be used for the uplink transmission. Thus, the terminal is not sure how to handle it in a case where the uplink transmissions occupy the first slot, specifically, for example, in a case where the frequency domain resource for the uplink transmission overlaps a downlink frequency domain resource outside the uplink subband corresponding to the first slot.

According to the embodiment of the present disclosure, in a case where the uplink transmissions occupy the first slot, the terminal can determine whether to perform the uplink transmission in the first slot according to the relation between the frequency domain resource for the uplink transmission to be performed in the first slot and the uplink subband in the first slot, such that it is ensured that the terminal can reasonably determine whether to perform the uplink transmission in the first slot in a case where the uplink transmissions to be performed in the plurality of slots occupy the first slot.

Moreover, since the uplink transmissions occupy the plurality of slots, even if it is determined that the uplink transmission is not performed in the first slot, impact on the uplink transmissions in the plurality of slots is relatively small, while resource collision is avoided advantageously.

In an embodiment, determining, according to the relation between the frequency domain resource for the uplink transmission in the first slot among the plurality of slots and the uplink subband in the first slot, whether to perform the uplink transmission in the first slot includes at least one of the following: not performing the uplink transmission in the first slot in a case where the frequency domain resource for the uplink transmission is located outside the uplink subband; or performing the uplink transmission in the first slot in a case where the frequency domain resource for the uplink transmission is located within the uplink subband.

For example, the uplink transmission may occupy a resource unusable for the uplink transmission in a case where the relation between the frequency domain resource for the uplink transmission to be performed in the first slot among the plurality of slots and the uplink subband in the first slot indicates that the frequency domain resource for the uplink transmission is located outside the uplink subband, which may result in the resource collision. Thus, it may be determined that the uplink transmission is not performed in the first slot, and the resource collision may be avoided.

For example, the uplink transmission may merely occupy a resource within the uplink subband in a case where the relation between the frequency domain resource for the uplink transmission to be performed in the first slot among the plurality of slots and the uplink subband in the first slot indicates that the frequency domain resource for the uplink transmission is located within the uplink subband, which may not cause the resource collision. Thus, it may be determined that the uplink transmission is performed in the first slot, and it is advantageously ensured that the uplink transmission is performed smoothly.

In an embodiment, a case that the frequency domain resource for the uplink transmission is located outside the uplink subband includes at least one of the following: a case that the frequency domain resource for the uplink transmission is completely located outside the uplink subband; or a case that the frequency domain resource for the uplink transmission is partially located outside the uplink subband.

For example, the frequency domain resource for the uplink transmission is located outside the uplink subband, which means that the frequency domain resource for the uplink transmission is completely located outside the uplink subband. In this case, the uplink transmission may occupy the resource unusable for the uplink transmission in a case where the relation between the frequency domain resource for the uplink transmission to be performed in the first slot among the plurality of time slots and the uplink subband in the first slot indicates that the frequency domain resource for the uplink transmission is completely located outside the uplink subband, which may result in the resource collision. Thus, it may be determined that the uplink transmission is not performed in the first slot, and the resource collision may be avoided.

For example, the frequency domain resource for the uplink transmission is located outside the uplink subband, which means that the frequency domain resource for the uplink transmission is partially located outside the uplink subband. In this case, the uplink transmission may occupy the resource unusable for the uplink transmission in a case where the relation between the frequency domain resource for the uplink transmission to be performed in the first slot among the plurality of slots and the uplink subband in the first slot indicates that the frequency domain resource for the uplink transmission is partially located outside the uplink subband, which may result in the resource collision. Thus, it may be determined that the uplink transmission is not performed in the first slot, and the resource collision may be avoided.

In an embodiment, a case that the frequency domain resource for the uplink transmission is located within the uplink subband includes at least one of the following: a case that the frequency domain resource for the uplink transmission is completely located within the uplink subband; or a case that the frequency domain resource for the uplink transmission is partially located within the uplink subband.

For example, the frequency domain resource for the uplink transmission is located within the uplink subband, which means that the frequency domain resource for the uplink transmission is completely located within the uplink subband. In this case, the uplink transmission may merely occupy the resource within the uplink subband in a case where the relation between the frequency domain resource for the uplink transmission to be performed in the first slot among the plurality of slots and the uplink subband in the first slot indicates that the frequency domain resource for the uplink transmission is completely located within the uplink subband, which may not cause the resource collision. Thus, it may be determined that the uplink transmission is performed in the first slot, and it is advantageously ensured that the uplink transmission is performed smoothly.

In an embodiment, performing the uplink transmission in the first slot includes: performing the uplink transmission in a part of the frequency domain resource for the uplink transmission in the first slot located within the uplink subband in a case where the frequency domain resource for the uplink transmission is partially located within the uplink subband.

For example, the frequency domain resource for the uplink transmission is located within the uplink subband, which means that the frequency domain resource for the uplink transmission is partially located within the uplink subband. In this case, the part of the frequency domain resource for the uplink transmission located within the uplink subband may not cause the resource collision in a case where the relation between the frequency domain resource for the uplink transmission to be performed in the first slot among the plurality of slots and the uplink subband in the first slot indicates that the frequency domain resource for the uplink transmission is partially located within the uplink subband. Thus, it may be determined that the uplink transmission is performed in the first slot. For example, the uplink transmission is performed merely by the part of the frequency domain resource for the uplink transmission located within the uplink subband, and it is advantageously ensured that the uplink transmission is performed smoothly.

Performing the uplink transmission merely by the part of the frequency domain resource for the uplink transmission located within the uplink subband may be implemented by rate matching, puncturing, etc. For example, puncturing is taken as an example. The terminal may puncture uplink transmission corresponding to a part of the frequency domain resource for the uplink transmission located outside the uplink subband. Thus, the uplink transmission is performed merely by the part of the frequency domain resource for the uplink transmission located within the uplink subband.

In an embodiment, the uplink transmission includes at least one of the following: a PUSCH for which a repetition is enabled; a PUSCH for which transport block processing over multi-slot (TBoMS) PUSCH is enabled; a PUSCH among a plurality of PUSCHs scheduled by single downlink control information (DCI); a configured grant (CG) PUSCH; a physical uplink control channel (PUCCH) for which a repetition is enabled; or a sounding reference signal (SRS).

In an embodiment, the PUSCH for which the repetition is enabled includes at least one of the following: a PUSCH for which R15 repetition type A is enabled; a PUSCH for which R16 repetition type A is enabled; a PUSCH for which R17 repetition type A is enabled and available slot counting is configured; or a PUSCH for which R16 repetition type B is enabled.

In an embodiment, the CG PUSCH includes at least one of the following: a type 1CG PUSCH; or a type 2 CG PUSCH.

In an embodiment, the frequency domain resource includes a frequency domain resource for the uplink transmissions to be performed in the plurality of slots in a case where inter-slot frequency hopping (inter-slot FH) is not enabled.

Under the condition that the inter-slot FH is not enabled, for the uplink transmissions to be performed in the plurality of slots, the frequency domain resources for the uplink transmissions in each of the plurality of slots may be the same. Thus, there is merely one case for the frequency domain resource for the uplink transmission, i.e., the frequency domain resources for the uplink transmissions to be performed in the plurality of slots.

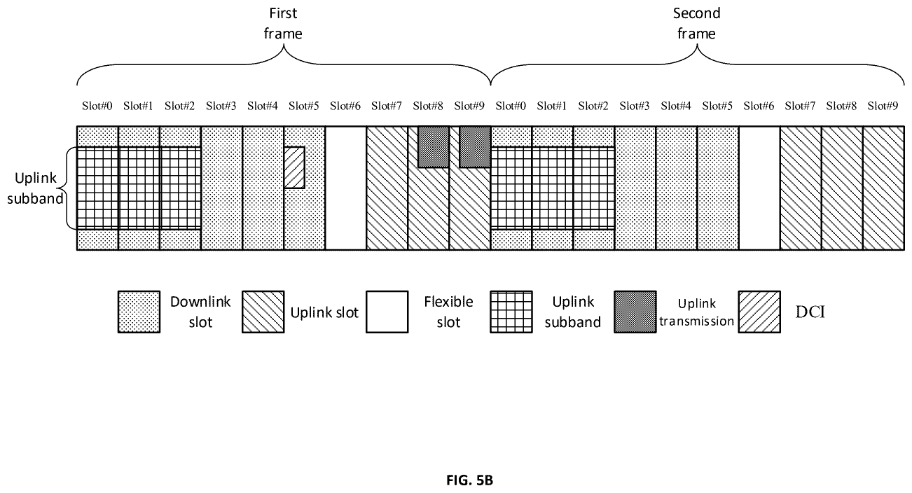

FIGS. 5A and 5B are schematic diagrams of application scenarios of a method for performing the uplink transmission according to an embodiment of the present disclosure.

For example, a frame includes 10 slots, the uplink transmission includes the PUSCH for which the repetition is enabled, the slot structure is DDDDDDSUUU, and the network device configures uplink subbands in a slot #0 to a slot #2.

As shown in FIGS. 5A and 5B, the network device sends DCI to the terminal in a slot #5 of a first frame, and schedules the terminal to start PUSCH repetition from a slot #8. The number of repetitions is 4.

In this case, a third PUSCH transmission and a fourth PUSCH transmission need to be performed in a slot #0 and a slot #1 of a second frame. The slot #0 and the slot #1 are first slots. Since the inter-slot FH is not enabled, frequency domain resources for the third PUSCH transmission and the fourth PUSCH transmission are the same.

According to the frequency domain resource for the PUSCH for which the repetition is enabled, a relation between the frequency domain resource and an uplink subband in the slot #0 and a relation between the frequency domain resource and an uplink subband in the slot #1 may be determined, and whether the third PUSCH transmission is performed in the slot #0 and whether the fourth PUSCH transmission is performed in the slot #1 may be determined.

As shown in FIG. 5A, the relation between the frequency domain resource for the PUSCH for which the repetition is enabled and the uplink subband may be determined. For example, the frequency domain resource for the PUSCH for which the repetition is enabled is completely located within the uplink subband, such that the third PUSCH transmission in the slot #0 and the fourth PUSCH transmission in the slot #1 may merely occupy the resources within the uplink subbands, and may not cause the resource collision. Thus, it may be determined that the third PUSCH transmission is performed in the slot #0 and the fourth PUSCH transmission is performed in the slot #1, and it is advantageously ensured that the uplink transmission is performed smoothly.

As shown in FIG. 5B, the relation between the frequency domain resource for the PUSCH for which the repetition is enabled and the uplink subband may be determined. For example, the frequency domain resource for the PUSCH for which the repetition is enabled is partially located within the uplink subband, such that the third PUSCH transmission in the slot #0 and the fourth PUSCH transmission in the slot #1 may occupy the resource outside the uplink subband, which may result in resource collision. Thus, it may be determined that the third PUSCH transmission is not performed in the slot #0, and the fourth PUSCH transmission is not performed in the slot #1, and the resource collision may be avoided advantageously.

In an embodiment, the frequency domain resource includes at least one of the following: a frequency domain resource for the uplink transmissions to be performed in the plurality of slots before frequency hopping in a case where the inter-slot FH is enabled; or a frequency domain resource for the uplink transmissions to be performed in the plurality of slots after the frequency hopping in a case where the inter-slot FH is enabled.

Under the condition that the inter-slot FH is enabled, since the frequency hopping may be performed in different slots, the frequency domain resources for the uplink transmissions in different slots may be different. Thus, for the uplink transmissions to be performed in the plurality of slots, the frequency domain resource for the uplink transmission may include a frequency domain resource before the frequency hopping and a frequency domain resource after the frequency hopping.

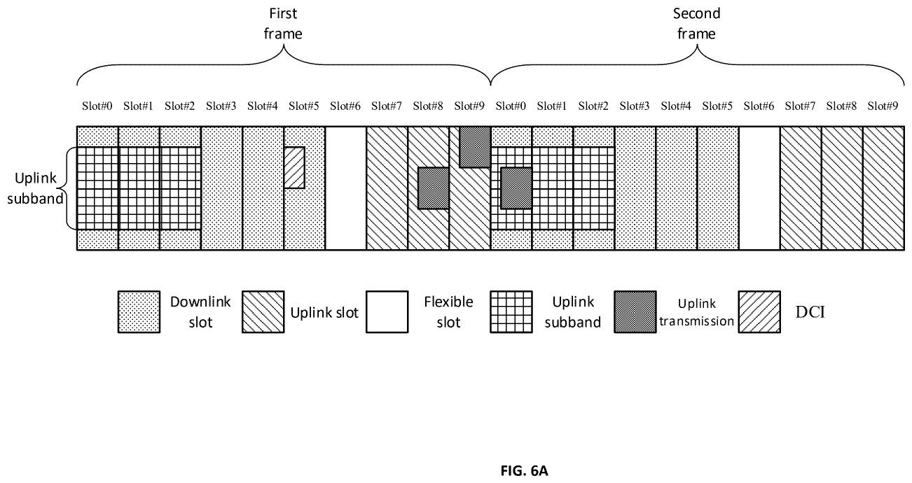

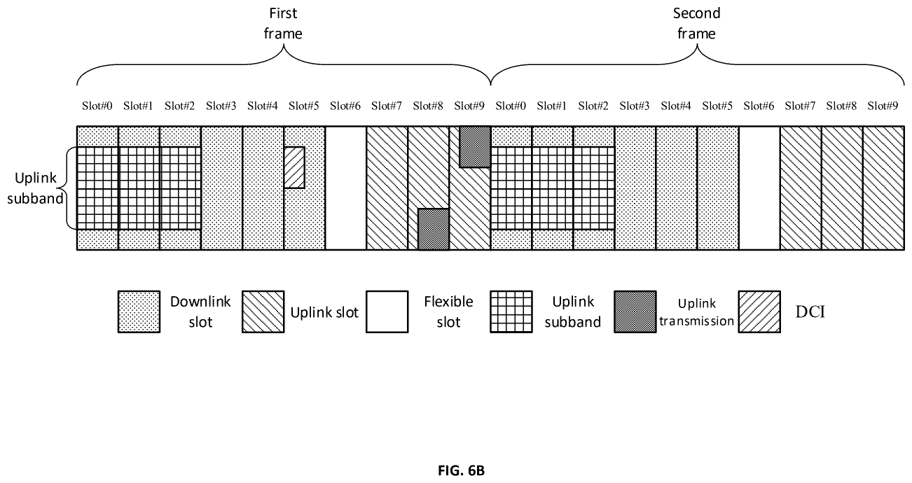

FIGS. 6A and 6B are schematic diagrams of application scenarios of another method for performing the uplink transmission according to an embodiment of the present disclosure.

For example, the frame includes 10 slots, the uplink transmission includes the PUSCH for which the repetition is enabled, the slot structure is DDDDDDSUUU, and the network device configures the uplink subbands in the slot #0 to the slot #2.

As shown in FIGS. 6A and 6B, the network device sends the DCI to the terminal in the slot #5 of the first frame, and schedules the terminal to start the PUSCH repetition from the slot #8. The number of repetitions is 4.

In this case, the third PUSCH transmission and the fourth PUSCH transmission need to be performed in the slot #0 and the slot #1 of the second frame. The slot #0 and the slot #1 are the first slots. Since the inter-slot FH is enabled, the frequency domain resources for the third PUSCH transmission and the fourth PUSCH transmission are different. For example, a difference (which is also referred to as an offset) between the frequency domain resource before the frequency hopping and the frequency domain resource after the frequency hopping is n resource blocks (RBs), where n may be determined based on protocol agreement, or indicated by the network device.

According to the frequency domain resource for the PUSCH for which the repetition is enabled, the relation between the frequency domain resource and the uplink subband in the slot #0 and the relation between the frequency domain resource and the uplink subband in the slot #1 may be determined, and whether the third PUSCH transmission is performed in the slot #0 and whether the fourth PUSCH transmission is performed in the slot #1 may be determined.

For example, a frequency domain resource for odd-numbered PUSCH transmission is referred to as the frequency domain resource before the frequency hopping, and a frequency domain resource for even-numbered PUSCH transmission is referred to as the frequency domain resource after the frequency hopping.

As shown in FIG. 6A, the relation between the frequency domain resource before the frequency hopping and the uplink subband, and the relation between the frequency domain resource after the frequency hopping and the uplink subband may be determined. For example, the frequency domain resource before the frequency hopping is completely located within the uplink subband, and the frequency domain resource after the frequency hopping is partially located outside the uplink subband. Thus, the third PUSCH transmission in the slot #0 may merely occupy the resource within the uplink subband, which may not cause the resource collision. Thus, it may be determined that the third PUSCH transmission is performed in the slot #0. However, the fourth PUSCH transmission in the slot #1 may occupy the resource outside the uplink subband, which may result in the resource collision. Thus, it may be determined that the fourth PUSCH transmission is not performed in the slot #1.

As shown in FIG. 6B, the relation between the frequency domain resource before the frequency hopping and the uplink subband, and the relation between the frequency domain resource after the frequency hopping and the uplink subband may be determined. For example, the frequency domain resource before the frequency hopping is partially located outside the uplink subband, and the frequency domain resource after the frequency hopping is partially located outside the uplink subband. Thus, the third PUSCH transmission in the slot #0 and the fourth PUSCH transmission in the slot #1 may occupy resources outside the uplink subbands, which may result in resource collision. Thus, it may be determined that the third PUSCH transmission is not performed in the slot #0, and the fourth PUSCH transmission is not performed in the slot #1.

In an embodiment, the terminal may determine whether to perform the uplink transmission in a second slot according to a relation between a frequency domain resource for the uplink transmission to be performed in the second slot and a downlink subband in the second slot.

In an embodiment, the uplink transmission is performed in the second slot in a case where the frequency domain resource for the uplink transmission is located outside the downlink subband.

In an embodiment, the uplink transmission is not performed in the second slot in a case where the frequency domain resource for the uplink transmission is located within the downlink subband.

For example, the uplink transmission may merely occupy a resource within the downlink subband and may not cause the resource collision in a case where the relation between the frequency domain resource for the uplink transmission to be performed in the second slot among the plurality of slots and the downlink subband in the second slot indicates that the frequency domain resource for the uplink transmission is located outside the downlink subband. Thus, it may be determined that the uplink transmission is performed in the second slot, and it is advantageously ensured that the uplink transmission is performed smoothly.

For example, the uplink transmission may occupy a resource unusable for the downlink transmission in a case where the relation between the frequency domain resource for the uplink transmission to be performed in the second slot among the plurality of slots and the downlink subband in the second slot indicates that the frequency domain resource for the uplink transmission is located within the downlink subband, which may result in the resource collision. Thus, it may be determined that the uplink transmission is not performed in the second slot, and the resource collision may be avoided.

In an embodiment, the method for performing the uplink transmission further includes: performing uplink transmissions in a first number of third slots in a case where it is determined that the uplink transmissions are not performed in the first number of first slots, where the first number of third slots are located after the plurality of slots and closest to the plurality of slots, and the first number of third slots are slots that are not configured with uplink subbands and comprise uplink resources.

The uplink transmissions occupying the plurality of slots may occupy a few slots in a case where the terminal determines that the uplink transmission is not performed in the first slot, which may result in a reduction in a number or content of uplink transmissions. In this case, the first number of the first slots occupied by the uplink transmissions not performed may be determined. For example, the first number is denoted as k. Thus, the uplink transmissions are performed in k third slots, so as to satisfy the number of the uplink transmissions or ensure the integrity of the content of the uplink transmissions, where the k third slots are located after the plurality of slots and closest to the plurality of slots.

FIG. 6C is a schematic diagram of a third slot according to an embodiment of the present disclosure.

As shown in FIG. 6C, for example, based on the embodiment shown in FIG. 6A, it may be determined that the fourth PUSCH transmission among the four PUSCH transmissions is not performed. Thus, the uplink transmission not performed occupies one first slot, and one third slot may be determined after the plurality of slots, i.e., after the slot #8 and a slot #9 of the first frame and the slot #0 and the slot #1 of the second frame.

According to the slot structure, it may be seen that after the slot #1 of the second frame, a closest non-SBFD including the uplink resource is a slot #7 of the second frame. Thus, a PUSCH transmission that may not be performed in the slot #1 may be performed in the slot #7 of the second frame. Accordingly, it may be ensured that the number of PUSCH repetitions reaches 4.

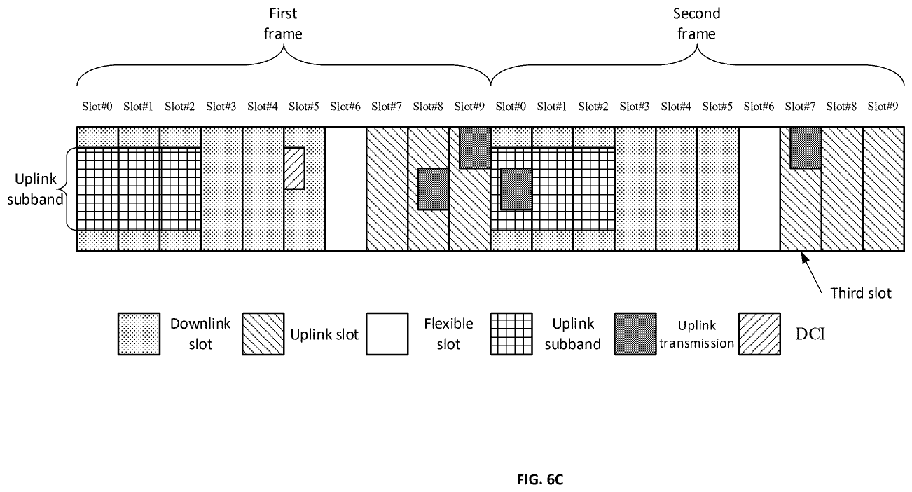

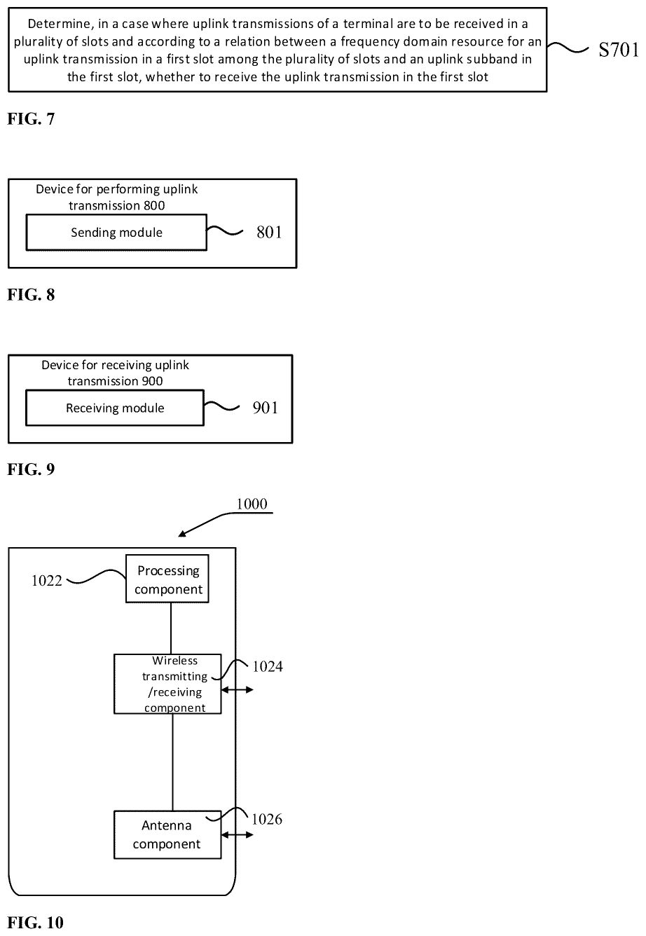

FIG. 7 is a schematic flowchart of a method for receiving uplink transmission according to an embodiment of the present disclosure. The method for receiving the uplink transmission, as shown in the embodiment, may be performed by a network device.

As shown in FIG. 7, the method for receiving the uplink transmission may include the following step S701.

In step S701, it is determined, in a case where uplink transmissions of a terminal are to be received in a plurality of slots and according to a relation between a frequency domain resource for an uplink transmission in a first slot among the plurality of slots and an uplink subband in the first slot, whether to receive the uplink transmission in the first slot.

It should be noted that the plurality of slots occupied by the uplink transmissions may include at least one first slot. The first slot in the embodiment of the present disclosure may be one first slot or a plurality of first slots of the at least one first slot.

In an embodiment, the network device configures the terminal to perform the uplink transmissions in the plurality of slots, and the uplink transmissions may occupy the plurality of slots. The uplink transmissions occupying the plurality of slots may include repetitions of a signal or a channel, or transmissions of a plurality of signals and/or a plurality of channels without repetitions. A type of the uplink transmission is described in subsequent embodiments, and is not described here.

The plurality of slots occupied by the uplink transmissions may be a plurality of continuous slots or a plurality of discontinuous slots, which is not limited in the present disclosure.

Since the uplink transmissions occupy the plurality of slots, it is difficult for the network device to ensure, in some cases, that each slot occupied by the uplink transmissions is a third slot in which a subband is not configured. The third slot includes at least one of the following: an uplink slot or a flexible slot.

For example, the uplink transmission includes a PUSCH for which a repetition is enabled. For example, the terminal is configured to repeat n PUSCH transmissions, and n PUSCHs occupy n slots. The network device may determine that one third slot is a slot of a first PUSCH transmission among the n PUSCH transmissions, but the first slot exists after the third slot. Since a second PUSCH transmission to an n-th PUSCH transmission among the n PUSCH transmissions may occupy n-1 slots after the third slot, it may be difficult to ensure that the first slot is not occupied. In a case where a PUSCH transmission needs to occupy the first slot, the first slot cannot be used for the PUSCH transmission since the first slot is configured with the uplink subband, and a resource outside the uplink subband may not be used for the uplink transmission. Thus, the network device is not sure how to handle it in a case where the uplink transmissions occupy the first slot, specifically, for example, in a case where the frequency domain resource for the uplink transmission overlaps a downlink frequency domain resource outside the uplink subband corresponding to the first slot.

According to the embodiment of the present disclosure, in a case where the uplink transmissions occupy the first slot, the network device can determine whether to receive the uplink transmission in the first slot according to the relation between the frequency domain resource for the uplink transmission to be received in the first slot and the uplink subband in the first slot, such that it is ensured that the network device can reasonably determine whether to receive the uplink transmission in the first slot in a case where the uplink transmissions to be received in the plurality of slots occupy the first slot.

Moreover, since the uplink transmissions occupy the plurality of slots, even if it is determined that the uplink transmission is not received in the first slot, the impact on the uplink transmissions in the plurality of slots is relatively small, while resource collision is avoided advantageously.

In an embodiment, determining, according to the relation between the frequency domain resource for the uplink transmission in the first slot among the plurality of slots and the uplink subband in the first slot, whether to receive the uplink transmission in the first slot includes at least one of the following: not receiving the uplink transmission in the first slot in a case where the frequency domain resource for the uplink transmission is located outside the uplink subband; or receiving the uplink transmission in the first slot in a case where the frequency domain resource for the uplink transmission is located within the uplink subband.

For example, the uplink transmission may occupy a resource unusable for the uplink transmission in a case where the relation between the frequency domain resource for the uplink transmission to be received in the first slot among the plurality of slots and the uplink subband in the first slot indicates that the frequency domain resource for the uplink transmission is located outside the uplink subband, which may result in the resource collision. Thus, it may be determined that the uplink transmission is not received in the first slot, and the resource collision may be avoided.

For example, the uplink transmission may merely occupy a resource within the uplink subband in a case where the relation between the frequency domain resource for the uplink transmission to be received in the first slot among the plurality of slots and the uplink subband in the first slot indicates that the frequency domain resource for the uplink transmission is located within the uplink subband, which may not cause the resource collision. Thus, it may be determined that the uplink transmission is received in the first slot, and it is advantageously ensured that the uplink transmission is received smoothly.

In an embodiment, a case that the frequency domain resource for the uplink transmission is located outside the uplink subband includes at least one of the following: a case that the frequency domain resource for the uplink transmission is completely located outside the uplink subband; or a case that the frequency domain resource for the uplink transmission is partially located outside the uplink subband.

For example, the frequency domain resource for the uplink transmission is located outside the uplink subband, which means that the frequency domain resource for the uplink transmission is completely located outside the uplink subband. In this case, the uplink transmission may occupy the resource unusable for the uplink transmission in a case where the relation between the frequency domain resource for the uplink transmission to be received in the first slot among the plurality of time slots and the uplink subband in the first slot indicates that the frequency domain resource for the uplink transmission is completely located outside the uplink subband, which may result in the resource collision. Thus, it may be determined that the uplink transmission is not received in the first slot, and the resource collision may be avoided.

For example, the frequency domain resource for the uplink transmission is located outside the uplink subband, which means that the frequency domain resource for the uplink transmission is partially located outside the uplink subband. In this case, the uplink transmission may occupy the resource unusable for the uplink transmission in a case where the relation between the frequency domain resource for the uplink transmission to be received in the first slot among the plurality of slots and the uplink subband in the first slot indicates that the frequency domain resource for the uplink transmission is partially located outside the uplink subband, which may result in the resource collision. Thus, it may be determined that the uplink transmission is not received in the first slot, and the resource collision may be avoided.

In an embodiment, a case that the frequency domain resource for the uplink transmission is located within the uplink subband includes at least one of the following: a case that the frequency domain resource for the uplink transmission is completely located within the uplink subband; or a case that the frequency domain resource for the uplink transmission is partially located within the uplink subband.

For example, the frequency domain resource for the uplink transmission is located within the uplink subband, which means that the frequency domain resource for the uplink transmission is completely located within the uplink subband. In this case, the uplink transmission may merely occupy the resource within the uplink subband in a case where the relation between the frequency domain resource for the uplink transmission to be received in the first slot among the plurality of slots and the uplink subband in the first slot indicates that the frequency domain resource for the uplink transmission is completely located within the uplink subband, which may not cause the resource collision. Thus, it may be determined that the uplink transmission is received in the first slot, and it is advantageously ensured that the uplink transmission is received smoothly.

In an embodiment, receiving the uplink transmission in the first slot includes: receiving the uplink transmission in a part of the frequency domain resource for the uplink transmission in the first slot located within the uplink subband in a case where the frequency domain resource for the uplink transmission is partially located within the uplink subband.

For example, the frequency domain resource for the uplink transmission is located within the uplink subband, which means that the frequency domain resource for the uplink transmission is partially located within the uplink subband. In this case, the part of the frequency domain resource for the uplink transmission located within the uplink subband may not cause the resource collision in a case where the relation between the frequency domain resource for the uplink transmission to be received in the first slot among the plurality of slots and the uplink subband in the first slot indicates that the frequency domain resource for the uplink transmission is partially located within the uplink subband. Thus, it may be determined that the uplink transmission is received in the first slot. For example, the uplink transmission is received merely by the part of the frequency domain resource for the uplink transmission located within the uplink subband, and it is advantageously ensured that the uplink transmission is received smoothly.

Receiving the uplink transmission merely by the part of the frequency domain resource for the uplink transmission located within the uplink subband may be implemented by rate matching, puncturing, etc. For example, puncturing is taken as an example. The terminal may puncture uplink transmission corresponding to a part of the frequency domain resource for the uplink transmission located outside the uplink subband. Thus, the network device receives the uplink transmission merely by the part of the frequency domain resource for the uplink transmission located within the uplink subband.

In an embodiment, the uplink transmission includes at least one of the following: a PUSCH for which a repetition is enabled; a PUSCH for which TBoMS PUSCH is enabled; a PUSCH among a plurality of PUSCHs scheduled by single DCI; a CG PUSCH; a PUSCH for which a repetition is enabled; or an SRS.

In an embodiment, the PUSCH for which the repetition is enabled includes at least one of the following: a PUSCH for which R15 repetition type A is enabled; a PUSCH for which R16 repetition type A is enabled; a PUSCH for which R17 repetition type A is enabled and available slot counting is configured; or a PUSCH for which R16 repetition type B is enabled.

In an embodiment, the CG PUSCH includes at least one of the following: a type 1CG PUSCH, or a type 2 CG PUSCH.

In an embodiment, the frequency domain resource includes a frequency domain resource for the uplink transmissions to be received in the plurality of slots in a case where inter-slot FH is not enabled.

Under the condition that the inter-slot FH is not enabled, for the uplink transmissions to be received in the plurality of slots, the frequency domain resources for the uplink transmissions in each of the plurality of slots may be the same. Thus, there is merely one case for the frequency domain resource for the uplink transmission, i.e., the frequency domain resources for the uplink transmissions to be received in the plurality of slots.

For example, a frame includes 10 slots, the uplink transmission includes the PUSCH for which the repetition is enabled, the slot structure is DDDDDDSUUU, and the network device configures uplink subbands in a slot #0 to a slot #2.

As shown in FIGS. 5A and 5B, the network device sends DCI to the terminal in a slot #5 of a first frame, and schedules the terminal to start PUSCH repetition from a slot #8. The number of repetitions is 4.

In this case, a third PUSCH transmission and a fourth PUSCH transmission need to be performed in a slot #0 and a slot #1 of a second frame. The slot #0 and the slot #1 are first slots. Since the inter-slot FH is not enabled, frequency domain resources for the third PUSCH transmission and the fourth PUSCH transmission are the same.

According to the frequency domain resource for the PUSCH for which the repetition is enabled, a relation between the frequency domain resource and an uplink subband in the slot #0 and a relation between the frequency domain resource and an uplink subband in the slot #1 may be determined, and whether the third PUSCH transmission is received in the slot #0 and whether the fourth PUSCH transmission is received in the slot #1 may be determined.

As shown in FIG. 5A, the relation between the frequency domain resource for the PUSCH for which the repetition is enabled and the uplink subband may be determined. For example, the frequency domain resource for the PUSCH for which the repetition is enabled is completely located within the uplink subband, such that reception of the third PUSCH transmission in the slot #0 and reception of the fourth PUSCH transmission in the slot #1 may merely occupy resources within the uplink subbands, and may not cause the resource collision. Thus, it may be determined that the third PUSCH transmission is received in the slot #0 and the fourth PUSCH transmission is received in the slot #1, and it is advantageously ensured that the uplink transmission is received smoothly.

As shown in FIG. 5B, the relation between the frequency domain resource for the PUSCH for which the repetition is enabled and the uplink subband may be determined. For example, the frequency domain resource for the PUSCH for which the repetition is enabled is partially located within the uplink subband, such that the reception of the third PUSCH transmission in the slot #0 and the reception of the fourth PUSCH transmission in the slot #1 may occupy resources outside the uplink subbands, which may result in the resource collision. Thus, it may be determined that the third PUSCH transmission is not received in the slot #0, and the fourth PUSCH transmission is not received in the slot #1, and the resource collision may be avoided advantageously.

In an embodiment, the frequency domain resource includes at least one of the following: a frequency domain resource for the uplink transmissions to be received in the plurality of slots before frequency hopping in a case where the inter-slot FH is enabled; or a frequency domain resource for the uplink transmissions to be received in the plurality of slots after the frequency hopping in a case where the inter-slot FH is enabled.

Under the condition that the inter-slot FH is enabled, the frequency domain resources for the uplink transmissions in different slots may be different since the frequency hopping may be performed in different slots. Thus, for the uplink transmissions to be received in the plurality of slots, the frequency domain resource for the uplink transmission may include a frequency domain resource before the frequency hopping and a frequency domain resource after the frequency hopping.

For example, a frame includes 10 slots, the uplink transmission includes the PUSCH for which the repetition is enabled, the slot structure is DDDDDDSUUU, and the network device configures the uplink subbands in the slot #0 to the slot #2.

As shown in FIGS. 6A and 6B, the network device sends the DCI to the terminal in the slot #5 of the first frame, and schedules the terminal to start the PUSCH repetition from the slot #8. The number of repetitions is 4.

In this case, the third PUSCH transmission and the fourth PUSCH transmission need to be performed in the slot #0 and the slot #1 of the second frame. The slot #0 and the slot #1 are the first slots. Since the inter-slot FH is enabled, the frequency domain resources for the third PUSCH transmission and the fourth PUSCH transmission are different. For example, a difference (which is also referred to as an offset) between the frequency domain resource before the frequency hopping and the frequency domain resource after the frequency hopping is n resource blocks (RBs), where n may be determined based on protocol agreement, or indicated by the network device.

According to the frequency domain resource for the PUSCH for which the repetition is enabled, the relation between the frequency domain resource and the uplink subband in the slot #0 and the relation between the frequency domain resource and the uplink subband in the slot #1 may be determined, and whether the third PUSCH transmission is received in the slot #0 and whether the fourth PUSCH transmission is received in the slot #1 may be determined.

For example, a frequency domain resource for odd-numbered PUSCH transmission is referred to as the frequency domain resource before the frequency hopping, and a frequency domain resource for even-numbered PUSCH transmission is referred to as the frequency domain resource after the frequency hopping.

As shown in FIG. 6A, the relation between the frequency domain resource before the frequency hopping and the uplink subband, and the relation between the frequency domain resource after the frequency hopping and the uplink subband may be determined. For example, the frequency domain resource before the frequency hopping is completely located within the uplink subband, and the frequency domain resource after the frequency hopping is partially located outside the uplink subband. Thus, reception of the third PUSCH transmission in the slot #0 may merely occupy the resource within the uplink subband, and may not cause the resource collision. Thus, it may be determined that the third PUSCH transmission is received in the slot #0. However, reception of the fourth PUSCH transmission in the slot #1 may occupy the resource outside the uplink subband, which may result in the resource collision. Thus, it may be determined that the fourth PUSCH transmission is not received in the slot #1.

As shown in FIG. 6B, the relation between the frequency domain resource before the frequency hopping and the uplink subband, and the relation between the frequency domain resource after the frequency hopping and the uplink subband may be determined. For example, the frequency domain resource before the frequency hopping is partially located outside the uplink subband, and the frequency domain resource after the frequency hopping is partially located outside the uplink subband. Thus, reception of the third PUSCH transmission in the slot #0 and reception of the fourth PUSCH transmission in the slot #1 may occupy the resources outside the uplink subbands, which may result in the resource collision. Thus, it may be determined that the third PUSCH transmission is not received in the slot #0, and the fourth PUSCH transmission is not received in the slot #1.

In an embodiment, the network device may determine whether to receive the uplink transmission in a second slot according to a relation between a frequency domain resource for the uplink transmission to be performed in the second slot and a downlink subband in the second slot.

In an embodiment, the uplink transmission is received in the second slot in a case where the frequency domain resource for the uplink transmission is located outside the downlink subband.

In an embodiment, the uplink transmission is not received in the second slot in a case where the frequency domain resource for the uplink transmission is located within the downlink subband.

For example, the uplink transmission may merely occupy a resource within the downlink subband and may not cause the resource collision in a case where the relation between the frequency domain resource for the uplink transmission to be received in the second slot among the plurality of slots and the downlink subband in the second slot indicates that the frequency domain resource for the uplink transmission is located outside the downlink subband. Thus, it may be determined that the uplink transmission is received in the second slot, and it is advantageously ensured that the uplink transmission is received smoothly.

For example, the uplink transmission may occupy a resource unusable for the downlink transmission in a case where the relation between the frequency domain resource for the uplink transmission to be received in the second slot among the plurality of slots and the downlink subband in the second slot indicates that the frequency domain resource for the uplink transmission is located within the downlink subband, which may result in the resource collision. Thus, it may be determined that the uplink transmission is not received in the second slot, and the resource collision may be avoided.

In an embodiment, the method for performing the uplink transmission further includes: receiving uplink transmissions in a first number of third slots in a case where it is determined that the uplink transmissions are not received in the first number of first slots, where the first number of third slots are located after the plurality of slots and closest to the plurality of slots, and the first number of third slots are slots that are not configured with uplink subbands and comprise uplink resources.

The uplink transmissions occupying the plurality of slots may occupy a few slots in a case where the network device determines that the uplink transmission of the terminal is not received in the first slot, which may result in a reduction in a number or content of uplink transmissions. In this case, the first number of the first slots occupied by the uplink transmissions not received may be determined. For example, the first number is denoted as k. Thus, the uplink transmissions are received in k third slots, so as to satisfy the number of the uplink transmissions or ensure the integrity of the content of the uplink transmissions, where the k third slots are located after the plurality of slots and closest to the plurality of slots.

As shown in FIG. 6C, for example, based on the embodiment shown in FIG. 6A, it may be determined that the fourth PUSCH transmission among the four PUSCH transmissions is not received. Thus, the uplink transmission not received occupies one first slot, and one third slot may be determined after the plurality of slots, i.e., after the slot #8 and a slot #9 of the first frame and the slot #0 and the slot #1 of the second frame.

According to the slot structure, it may be seen that after the slot #1 of the second frame, a closest non-SBFD including the uplink resource is a slot #7 of the second frame. Thus, a PUSCH transmission that may not be received in the slot #1 may be received in the slot #7 of the second frame. Accordingly, it may be ensured that the number of PUSCH repetitions reaches 4.

A communication method is further provided in an embodiment of the present disclosure. The communication method is performed by a communication system 10. The communication system includes the network device 30 and the terminal 20.

In an embodiment, the terminal 20 is configured to determine, in a case where uplink transmissions are to be performed in the plurality of slots and according to the relation between the frequency domain resource for the uplink transmission in the first slot among the plurality of slots and the uplink subband in the first slot, whether to perform the uplink transmission in the first slot.

In an embodiment, the network device 30 is configured to determine, in a case where the uplink transmissions of the terminal are to be received in the plurality of slots and according to the relation between the frequency domain resource for the uplink transmission in the first slot among the plurality of slots and the uplink subband in the first slot, whether to receive the uplink transmission in the first slot.

It should be noted that reference is made to the description of relevant contents in each embodiment of the above for other contents involved in the embodiment, which are not repeated here.

In correspondence to the above embodiments of the method for performing uplink transmission and the method for receiving uplink transmission, the present disclosure further provides embodiments of a device for performing uplink transmission and a device for receiving uplink transmission.

FIG. 8 is a schematic block diagram of a device 800 for performing uplink transmission according to an embodiment of the present disclosure. As shown in FIG. 8, the device 800 for performing uplink transmission includes:
a sending module 801 configured to determine, in a case where uplink transmissions are performed in a plurality of slots and according to a relation between a frequency domain resource for an uplink transmission in a first slot among the plurality of slots and an uplink subband in the first slot, whether to perform the uplink transmission in the first slot.

In an embodiment, the sending module 801 is configured to perform at least one of the following operations: not performing the uplink transmission in the first slot in a case where the frequency domain resource for the uplink transmission is located outside the uplink subband; or performing the uplink transmission in the first slot in a case where the frequency domain resource for the uplink transmission is located within the uplink subband.

In an embodiment, a case that the frequency domain resource for the uplink transmission is located outside the uplink subband includes at least one of the following: a case that the frequency domain resource for the uplink transmission is completely located outside the uplink subband; or a case that the frequency domain resource for the uplink transmission is partially located outside the uplink subband.

In an embodiment, a case that the frequency domain resource for the uplink transmission is located within the uplink subband includes at least one of the following: a case that the frequency domain resource for the uplink transmission is completely located within the uplink subband; or a case that the frequency domain resource for the uplink transmission is partially located within the uplink subband.

In an embodiment, the sending module 801 is configured to perform the uplink transmission in a part of the frequency domain resource for the uplink transmission in the first slot located within the uplink subband in a case where the frequency domain resource for the uplink transmission is partially located within the uplink subband.

In an embodiment, the frequency domain resource includes a frequency domain resource for the uplink transmissions to be performed in the plurality of slots in a case where inter-slot frequency hopping is not enabled.

In an embodiment, the frequency domain resource includes at least one of the following: a frequency domain resource for the uplink transmissions to be performed in the plurality of slots before frequency hopping in a case where inter-slot FH is enabled; or a frequency domain resource for the uplink transmissions to be performed in the plurality of slots after the frequency hopping in a case where the inter-slot FH is enabled.

In an embodiment, the uplink transmission includes at least one of the following: a PUSCH for which a repetition is enabled; a PUSCH for which TBoMS PUSCH is enabled; a PUSCH among a plurality of PUSCHs scheduled by single DCI; a CG PUSCH; a PUSCH for which a repetition is enabled; or an SRS.

In an embodiment, the PUSCH for which the repetition is enabled includes at least one of the following: a PUSCH for which R15 repetition type A is enabled; a PUSCH for which R16 repetition type A is enabled; a PUSCH for which R17 repetition type A is enabled and available slot counting is configured; or a PUSCH for which R16 repetition type B is enabled.

In an embodiment, the CG PUSCH includes at least one of the following: a type 1 CG PUSCH, or a type 2 CG PUSCH.

In an embodiment, the sending module 801 is further configured to perform uplink transmissions in a first number of third slots in a case where it is determined that the uplink transmissions are not performed in the first number of first slots, where the first number of third slots are located after the plurality of slots and closest to the plurality of slots, and the first number of third slots are slots that are not configured with uplink subbands and comprise uplink resources.

FIG. 9 is a schematic block diagram of a device 900 for receiving uplink transmission according to an embodiment of the present disclosure. As shown in FIG. 9, the device 900 for receiving uplink transmission includes:
a receiving module 901 configured to determine, in a case where uplink transmissions of a terminal are to be received in a plurality of slots and according to a relation between a frequency domain resource for an uplink transmission in a first slot among the plurality of slots and an uplink subband in the first slot, whether to receive the uplink transmission in the first slot.

In an embodiment, the receiving module 901 is configured to perform at least one of the following operations: not receiving the uplink transmission in the first slot in a case where the frequency domain resource for the uplink transmission is located outside the uplink subband; or receiving the uplink transmission in the first slot in a case where the frequency domain resource for the uplink transmission is located within the uplink subband.

In an embodiment, a case that the frequency domain resource for the uplink transmission is located outside the uplink subband includes at least one of the following: a case that the frequency domain resource for the uplink transmission is completely located outside the uplink subband; or a case that the frequency domain resource for the uplink transmission is partially located outside the uplink subband.

In an embodiment, a case that the frequency domain resource for the uplink transmission is located within the uplink subband includes at least one of the following: a case that the frequency domain resource for the uplink transmission is completely located within the uplink subband; or a case that the frequency domain resource for the uplink transmission is partially located within the uplink subband.

In an embodiment, the receiving module 901 is configured to receive the uplink transmission in a part of the frequency domain resource for the uplink transmission in the first slot located within the uplink subband in a case where the frequency domain resource for the uplink transmission is partially located within the uplink subband.

In an embodiment, the frequency domain resource includes a frequency domain resource for the uplink transmissions to be received in the plurality of slots in a case where inter-slot FH is not enabled.

In an embodiment, the frequency domain resource includes at least one of the following: a frequency domain resource for the uplink transmissions to be received in the plurality of slots before frequency hopping in a case where inter-slot FH is enabled; or a frequency domain resource for the uplink transmissions to be received in the plurality of slots after the frequency hopping in a case where the inter-slot FH is enabled.

In an embodiment, the uplink transmission includes at least one of the following: a PUSCH for which a repetition is enabled; a PUSCH for which TBoMS PUSCH is enabled; a PUSCH among a plurality of PUSCHs scheduled by single DCI; a CG PUSCH; a PUCCH for which a repetition is enabled; or an SRS.

In an embodiment, the PUSCH for which the repetition is enabled includes at least one of the following: a PUSCH for which R15 repetition type A is enabled; a PUSCH for which R16 repetition type A is enabled; a PUSCH for which R17 repetition type A is enabled and available slot counting is configured; or a PUSCH for which R16 repetition type B is enabled.

In an embodiment, the CG PUSCH includes at least one of the following: a type 1 CG PUSCH, or a type 2 CG PUSCH.

In an embodiment, the receiving module 901 is further configured to receive uplink transmissions in a first number of third slots in a case where it is determined that the uplink transmissions are not received in the first number of first slots, where the first number of third slots are located after the plurality of slots and closest to the plurality of slots, and the first number of third slots are slots that are not configured with uplink subbands and comprise uplink resources.

Since the device embodiment substantially corresponds to the method embodiment, it is sufficient to refer to part of the description of the method embodiment where relevant. The device embodiment described above is merely schematic. The module described as a separate component may be physically separated or not, and a component displayed as a module may be a physical module or not. To be specific, the component may be located at one place or distributed on a plurality of network modules. Some or all of the modules can be selected according to actual needs to achieve the purpose of the solution of the embodiment. Those of ordinary skill in the art can understand and implement the present disclosure without making creative efforts.

A communication system is further provided in an embodiment of the present disclosure. The communication system includes a terminal and a network device. The terminal is configured to implement the method for performing uplink transmission according to any one of the above embodiments, and the network device is configured to implement the method for receiving uplink transmission of any one of the above embodiments.

A communication device is further provided in an embodiment of the present disclosure. The communication device includes a processor and a memory configured to store a computer program, where the computer program, when executed by the processor, implements the method for performing uplink transmission as described in any one of the above embodiments.

A communication device is further provided in an embodiment of the present disclosure. The communication device includes a processor and a memory configured to store a computer program, where the computer program, when executed by the processor, implements the method for receiving uplink transmission of any one of the above embodiments.

A computer-readable storage medium is further provided in an embodiment of the present disclosure. The computer-readable storage medium is configured to store a computer program, and the computer program implements the method for performing uplink transmission of any one of the above embodiments when executed by a processor.

A computer-readable storage medium is further provided in an embodiment of the present disclosure. The computer-readable storage medium is configured to store a computer program, and the computer program implements the method for receiving uplink transmission as in any one of the above embodiments when executed by a processor.

As shown in FIG. 10, a schematic block diagram of a device 1000 for receiving uplink transmission according to an embodiment of the present disclosure is shown. The device 1000 may be a base station. With reference to FIG. 10, the device 1000 includes a processing component 1022, a wireless transmitting/receiving component 1024, an antenna component 1026, and a signal processing portion specific to a wireless interface. The processing component 1022 may further include one or more processors. One of the processors in the processing component 1022 may be configured to implement the method for receiving uplink transmission of any one of the above embodiments.

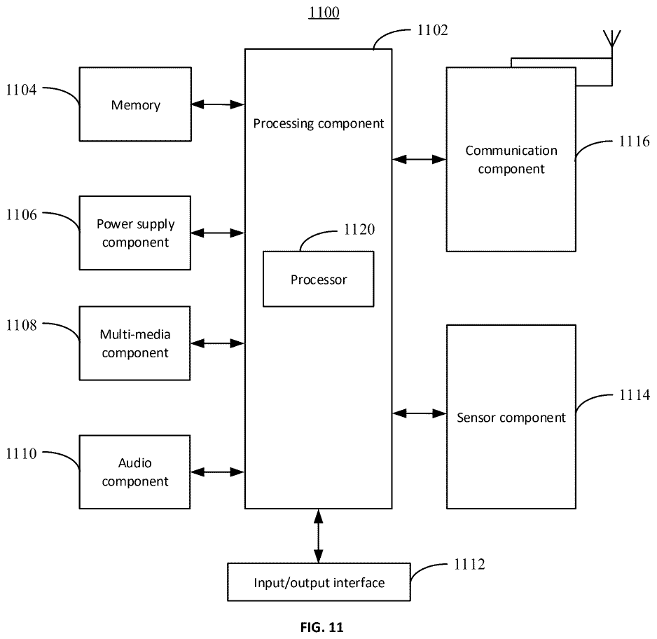

FIG. 11 is a schematic block diagram of a device 1100 for performing uplink transmission according to an embodiment of the present disclosure. For example, the device 1100 may be a terminal, and may be, for example, a mobile phone, a computer, a digital broadcast terminal, a message transceiver apparatus, a game console, a tablet apparatus, a medical apparatus, a fitness apparatus, a personal digital assistant, etc.

With reference to FIG. 11, the device 1100 may include one or more of the following components: a processing component 1102, a memory 1104, a power supply component 1106, a multi-media component 1108, an audio component 1110, an input/output (I/O) interface 1112, a sensor component 1114, and a communication component 1116.

Overall operations of the device 1100, such as operations associated with display, phone calls, data communications, camera operations, and recording operations, are generally controlled by the processing component 1102. The processing component 1102 may include one or more processors 1120 to execute instructions to implement all or part of the steps of the method for performing uplink transmission of any one of the above embodiments. Further, the processing component 1102 may include one or more modules that facilitate interaction between the processing component 1102 and other components. For example, the processing component 1102 may include a multi-media module, so as to facilitate interaction between the multi-media component 1108 and the processing component 1102.

The memory 1104 is configured to store any type of data to support operations at the device 1100. Examples of such data include instructions, contact data, phone book data, messages, pictures, videos, etc., for any application or method operated on the device 1100.

Power is provided by the power supply component 1106 for various components of the device 1100. The power supply component 1106 may include a power management system, one or more power supplies, and other components associated with the generation, management, and distribution of power for the device 1100.

The multi-media component 1108 includes a screen that provides an output interface between the device 1100 and a user. In some embodiments, a screen may include a liquid crystal display (LCD) and a touch panel (TP). If the screen includes the TP, the screen may be implemented as a touch screen to receive an input signal from a user.

The audio component 1110 is configured to output and/or input an audio signal. For example, the audio component 1110 includes a microphone (MIC). The MIC is configured to receive an external audio signal in a case where the device 1100 is in an operating mode, such as a call mode, a recording mode, and a voice recognition mode. The received audio signal may be further stored in the memory 1104 or sent via the communication component 1116. In some embodiments, an audio component 1110 further includes a loudspeaker configured to output an audio signal.

The I/O interface 1112 provides an interface between the processing component 1102 and a peripheral interface module. The above peripheral interface module may be a keyboard, a click wheel, a button, etc. The button may include, but is not limited to, a home button, a volume button, a start button, and a lock button.

The sensor component 1114 includes one or more sensors configured to provide state assessments of various aspects of the device 1100.

The communication component 1116 is configured to facilitate communication between the device 1100 and other apparatuses in a wired or wireless manner. A wireless network based on a communication standard, such as wireless fidelity (WiFi), second-generation mobile communication (2G), third-generation mobile communication (3G), fourth-generation mobile communication long term evolution (4G LTE), fifth-generation mobile communication new radio (5G NR) or a combination of the WiFi, the 2G, the 3G, the 4G LTE and the 5G NR, may be accessed by the device 1100. In an example, a broadcast signal or broadcast related information from an external broadcast management system is received by a communication component 1116 via a broadcast channel. In an example, a communication component 1116 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, a device 1100 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, micro-processors, or other electronic elements, and is configured to perform the method for performing uplink transmission of any one of the above embodiments.

In an example, a non-transitory computer-readable storage medium including instructions is further provided, such as a memory 1104 including instructions. The instructions are executable by a processor 1120 of a device 1100, so as to complete the method for performing uplink transmission of any one of the above embodiments. For example, the non-transitory computer-readable storage medium may be a read only memory (ROM), a random access memory (RAM), a compact disc read-merely memory (CD-ROM), a magnetic tape, a floppy disk, an optical data storage apparatus, etc.

Those skilled in the art easily conceive of other implementation solutions of the present disclosure upon consideration of the description and practice of the disclosure disclosed here. The present disclosure is intended to cover any variations, uses, or adaptive changes of the present disclosure. The variations, uses, or adaptive changes follow the general principles of the present disclosure and include common general knowledge or customary technical means, which are not disclosed in the present disclosure, in the technical field. The description and the embodiments are to be regarded as illustrative merely, and the true scope and spirit of the present disclosure are indicated by the appended claims.

It should be understood that the present disclosure is not limited to a precise structure which has been described above and illustrated in the accompanying drawings, and can have various modifications and changes without departing from the scope of the present disclosure. The scope of the present disclosure is limited by the appended claims merely.

1. A method for performing uplink transmission, performed by a terminal, comprising:
determining, in a case where uplink transmissions are to be performed in a plurality of slots and according to a relation between a frequency domain resource for an uplink transmission in a first slot among the plurality of slots and an uplink subband in the first slot, whether to perform the uplink transmission in the first slot.

2. The method according to claim 1, wherein determining, according to the relation between the frequency domain resource for the uplink transmission in the first slot among the plurality of slots and the uplink subband in the first slot, whether to perform the uplink transmission in the first slot comprises at least one of:
not performing the uplink transmission in the first slot in a case where the frequency domain resource for the uplink transmission is located outside the uplink subband; or
performing the uplink transmission in the first slot in a case where the frequency domain resource for the uplink transmission is located within the uplink subband.

3. The method according to claim 2, wherein
a case that the frequency domain resource for the uplink transmission is located outside the uplink subband comprises at least one of:
a case that the frequency domain resource for the uplink transmission is completely located outside the uplink subband, or
a case that the frequency domain resource for the uplink transmission is partially located outside the uplink subband; and
a case that the frequency domain resource for the uplink transmission is located within the uplink subband comprises at least one of:
a case that the frequency domain resource for the uplink transmission is completely located within the uplink subband, or
a case that the frequency domain resource for the uplink transmission is partially located within the uplink subband.

4. (canceled)

5. The method according to claim 3, wherein performing the uplink transmission in the first slot comprises:
performing the uplink transmission in a part of the frequency domain resource for the uplink transmission in the first slot located within the uplink subband in a case where the frequency domain resource for the uplink transmission is partially located within the uplink subband.

6. The method according to claim 1, wherein the frequency domain resource comprises:
a frequency domain resource for the uplink transmissions to be performed in the plurality of slots in a case where inter-slot frequency hopping is not enabled.

7. The method according to claim 1, wherein the frequency domain resource comprises at least one of:
a frequency domain resource for the uplink transmissions to be performed in the plurality of slots before frequency hopping in a case where inter-slot frequency hopping is enabled; or
a frequency domain resource for the uplink transmissions to be performed in the plurality of slots after the frequency hopping in a case where the inter-slot frequency hopping is enabled.

8. The method according to claim 1, wherein the uplink transmission comprises at least one of:
a physical uplink shared channel for which a repetition is enabled;
a physical uplink shared channel for which transport block processing over multi-slot physical uplink shared channel is enabled;
a physical uplink shared channel among a plurality of physical uplink shared channels scheduled by single downlink control information;
a configured grant physical uplink shared channel;
a physical uplink control channel for which a repetition is enabled; or
a sounding reference signal.

9. The method according to claim 8, wherein
the physical uplink shared channel for which the repetition is enabled comprises at least one of:
a physical uplink shared channel for which R15 repetition type A is enabled,
a physical uplink shared channel for which R16 repetition type A is enabled,
a physical uplink shared channel for which R17 repetition type A is enabled and available slot counting is configured, or
a physical uplink shared channel for which R16 repetition type B is enabled, and
the configured grant physical uplink shared channel comprises at least one of:
a type 1 configured grant physical uplink shared channel, or
a type 2 configured grant physical uplink shared channel.

10. (canceled)

11. The method according to claim 1, further comprising:
performing uplink transmissions, which are not performed in a first number of first slots, in the first number of third slots, wherein the first number of third slots are located after the plurality of slots and closest to the plurality of slots, and the first number of third slots are not configured with uplink subbands and comprise uplink resources.

12. A method for receiving uplink transmission, performed by a network device, comprising:
determining, in a case where uplink transmissions of a terminal are to be received in a plurality of slots and according to a relation between a frequency domain resource for an uplink transmission in a first slot among the plurality of slots and an uplink subband in the first slot, whether to receive the uplink transmission in the first slot.

13. The method according to claim 12, wherein determining, according to the relation between the frequency domain resource for the uplink transmission in the first slot among the plurality of slots and the uplink subband in the first slot, whether to receive the uplink transmission in the first slot comprises at least one of:
not receiving the uplink transmission in the first slot in a case where the frequency domain resource for the uplink transmission is located outside the uplink subband; or
receiving the uplink transmission in the first slot in a case where the frequency domain resource for the uplink transmission is located within the uplink subband.

14. The method according to claim 13, wherein
a case that the frequency domain resource for the uplink transmission is located outside the uplink subband comprises at least one of:
a case that the frequency domain resource for the uplink transmission is completely located outside the uplink subband, or
a case that the frequency domain resource for the uplink transmission is partially located outside the uplink subband, and
a case that the frequency domain resource for the uplink transmission is located within the uplink subband comprises at least one of:
a case that the frequency domain resource for the uplink transmission is completely located within the uplink subband, or
a case that the frequency domain resource for the uplink transmission is partially located within the uplink subband.

15. (canceled)

16. The method according to claim 14, wherein receiving the uplink transmission in the first slot comprises:
receiving the uplink transmission in a part of the frequency domain resource for the uplink transmission in the first slot located within the uplink subband in a case where the frequency domain resource for the uplink transmission is partially located within the uplink subband.

17. The method according to claim 12, wherein the frequency domain resource comprises:
a frequency domain resource for the uplink transmissions to be received in the plurality of slots in a case where inter-slot frequency hopping is not enabled.

18. The method according to claim 12, wherein the frequency domain resource comprises at least one of:
a frequency domain resource for the uplink transmissions to be received in the plurality of slots before frequency hopping in a case where inter-slot frequency hopping is enabled; or
a frequency domain resource for the uplink transmissions to be received in the plurality of slots after the frequency hopping in a case where the inter-slot frequency hopping is enabled.

19. The method according to any one of claim 12, wherein the uplink transmission comprises at least one of:
a physical uplink shared channel for which a repetition is enabled;
a physical uplink shared channel for which transport block processing over multi-slot physical uplink shared channel is enabled;
a physical uplink shared channel among a plurality of physical uplink shared channels scheduled by single downlink control information;
a configured grant physical uplink shared channel;
a physical uplink control channel for which a repetition is enabled; or
a sounding reference signal.

20. The method according to claim 19, wherein
the physical uplink shared channel for which the repetition is enabled comprises at least one of:
a physical uplink shared channel for which R15 repetition type A is enabled,
a physical uplink shared channel for which R16 repetition type A is enabled,
a physical uplink shared channel for which R17 repetition type A is enabled and available slot counting is configured, or
a physical uplink shared channel for which R16 repetition type B is enabled; and
the configured grant physical uplink shared channel comprises at least one of:
a type 1 configured grant physical uplink shared channel, or
a type 2 configured grant physical uplink shared channel.

21. (canceled)

22. The method according to claim 12, further comprising:
receiving uplink transmissions, which are not received in a first number of first slots, in the first number of third slots, wherein the first number of third slots are located after the plurality of slots and closest to the plurality of slots, and the first number of third slots are not configured with uplink subbands and comprise uplink resources.

23-25. (canceled)

26. A communication device, comprising:
a processor; and
a memory configured to store a computer program, wherein the computer program, when executed by the processor, implements:
determining, in a case where uplink transmissions are to be performed in a plurality of slots and according to a relation between a frequency domain resource for an uplink transmission in a first slot among the plurality of slots and an uplink subband in the first slot, whether to perform the uplink transmission in the first slot.

27. A communication device, comprising:
a processor; and
a memory configured to store a computer program, wherein
the computer program, when executed by the processor, implements the method for receiving uplink transmission according to claim 12.

28-29. (canceled)
